(19) United States
(12) Patent Application Publication
(10) Pub. No.: US 2016/0321940 A1
(43) Pub. Date: Nov. 3, 2016

(54) Driver Education and Training System and Method for Training Drivers in Simulated Emergencies

(71) Applicant: Ivan Banga, Newnan, GA (US)

(72) Inventor: Ivan Banga, Newnan, GA (US)

(21) Appl. No.: 14/699,028

(22) Filed: Apr. 29, 2015

(51) Int. Cl. G09B 9/05

(52) U.S. Cl. CPC G09B 9/05

(57) ABSTRACT

The “Real Driving” driver education system combines specifically prepared surfaces of an outdoor driving training area preferably extending a length of approximately 600 feet and computer-generated, “augmented reality” images. This system requires the use of the actual vehicle owned by the trainee and/or used in his/her employment. Several field devices and sensors integral to the prepared area send signals to a portable computer, which can generate a variety of augmented and real driving hazards, including “water curtains,” to a head-mounted display worn by the driver. The driver/trainee will drive his/her vehicle through various stages and simulations, thus exposing him/her to challenging driving situations. Failing to perform proper maneuvers will result in losing control over the vehicle and probable spin-outs or sliding. Applying adequate steering, braking, and/or acceleration corrections will result in successful execution of each scenario.

### CROSS-REFERENCES TO RELATED APPLICATIONS

Not applicable

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept disclosed, the Reality Driving Education System (RDES) is, in a very general sense, related to different methods of training drivers of motor vehicles.

It is very difficult to train drivers so as to give them experience in encountering hazardous road conditions without also compromising the safety of the driver. Examples of such hazardous road conditions may include slippery roads, unexpectedly appearing obstacles, over-speeding on sharp turns, etc. Training by means of simulating these conditions while the driver is operating the vehicle generally addresses the above issues.

A variety of methods of providing the above-identified training scenarios have dealt with simulation of such driving experiences. Those methods broadly fail into two categories: (1) modifications of stock vehicles to simulate hazardous road conditions, and (2) complete computer-based simulated driving environments which do not usually involve an actual vehicle but a mechanical, computerized simulator.

Modifications of stock vehicles usually calls for a dedicated vehicle to be used only for training, which cannot be otherwise used for driving under actual real-life driving, situations. Simulation of the hazardous road conditions in such dedicated high-performance vehicles usually provides realistic haptic and motion feedback, while the spectrum of simulated experiences is limited mostly to the inducement of tire skids.

Computer-based simulated driving environments, while providing the most effective training benefits, require a dedicated and continuously maintained floor space. They also frequently require a detailed, realistic car cabin to be used in order to achieve a high enough degree of realism of the simulation. When the kind of training vehicle needs to be changed, the changeover usually calls for a cabin replacement, which is very costly and time consuming. An important consideration is the fact that neither of the above-described driver training methods (1), (2) allow a driver to obtain the obvious advantage of training conducted while driving his/her own vehicle.

For these reasons, the present inventive concept addresses the need to provide the sensation of mobility and the realistic feel of driving an actual vehicle while not exposing the driver to the dangers of an actual hazardous road situation during training. In the preferred embodiment, the disclosed driving trainer course is laid out over an area roughly the size of two football fields laid end-to-end. The system of the present inventive concept may also be quickly set-up and used on a hard-surfaced parking lot

(2) Description of the Related Art, Including Information Disclosed Under 37 CFR 1.97 and 1.98.

US Published Patent Application #2014/0358430 A1 (Dec. 4, 2014; A system for evaluating driver performance comprising: a GPS (Global Positioning System) navigation module for locating a vehicle driven by a driver; a running vehicle data collection module for collecting data of the vehicle; a vehicle specifications memory for storing specifications of the vehicle; a road maps memory for storing a plurality of maps of an area so as to identify the location of the vehicle by cooperating with the GPS navigation module; a road evaluation parameters memory for storing road evaluation parameters of the vehicle, and outputting a plurality of evaluation parameters of the vehicle by cooperating with the road maps memory.

US Published Patent Application #2014/0095135 (Apr. 3, 2014). Portable simulation system is a computer-based driving simulator, which uses an actual vehicle as an input device, and a portable display to present a Virtual Driving Environment (VDE) to the driver. Vehicle's steered wheels are placed atop of the turntables permitting free operation of the steering wheel. The vehicle remains immobile while its engine and power steering can be turned off during the simulation. External non-invasive sensors can be placed under the gas and brake pedals, permitting any vehicle to be used in the simulator, including the driver's own vehicle. A digital interface to the vehicle's systems, like OBD II, can be used to increase the fidelity of the simulation.

US Published Patent Application #2013/0142385 (Jun. 6, 2013). A method to display a ghosting image upon a transparent windscreen head-up display in a vehicle includes monitoring an operating environment of the vehicle, monitoring a driver registration input, determining a registered desired location graphic illustrating a future desired location for the vehicle based upon the operating environment of the vehicle and the driver registration input, and displaying the registered desired location graphic upon the head-up display.

U.S. Pat. No. 8,412,499 (Apr. 2, 2013) The portable simulation system is a computer-based driving simulator, which uses an actual vehicle as an input device, and a portable display to present a Virtual Driving Environment (VDE) to the driver. The vehicle's steered wheels are placed atop turntables permitting free operation of the steering wheel. The vehicle remains immobile while its engine and power steering can be turned off during the simulation. External non-invasive sensors can be placed under the gas and brake pedals, permitting any vehicle to be used in the simulator, including the driver's own vehicle. A digital interface to the vehicle's systems, like OBD II, can be used to increase the fidelity of the simulation. A portable computer used for driving simulation and VDE presentation provides a low cost simulation option.

U.S. Published Patent Application #2012/0196252; (Aug. 2, 2012) Disclosed is a driver training device that can be utilized to simulate the back of a moving vehicle. The training device can be utilized in a driver training program to help students learn proper distancing and how to avoid dangerous tailgating practices. A device can include a driver training apparatus comprising a taillight assembly that includes brake lights and/or other features to simulate the back of a moving vehicle. A training device can simulate the back of one or two vehicles, and can be powered by attachment to a lead vehicle or alternatively to a movable track.

US Published Patent Application 2011/0254655 A1 (Oct. 20, 2011) The invention is a method and system for monitoring and controlling driver performance in a controlled driving environment. A portable information device is provided to a driver who registers with a server computer for controlling vehicle operation in the driving environment. A record for the driver is stored in a database associated with the server computer. The driver's performance is monitored in the controlled driving environment and each driving violation that occurs is determined.

US Published Patent Application #2009/0028639 (Jan. 29, 2009). Disclosed is a driver training device that facilitates practicing vehicle maneuverability tasks to help develop vehicle maneuverability skills. In one embodiment, the device includes a plurality of boundary markers interconnected by flexible connecting members. The flexible connecting members are movable from first positions wherein the boundary markers are in a compact arrangement, to second positions wherein the boundary markers are located in a predetermined arrangement and spacing that facilitates practicing a vehicle maneuverability task.

U.S. Pat. No. 7,246,050 (Jul. 17, 2007) This invention provides in a safe and effective manner the experience of observing potential collision obstacles or other hazard images to the human operator of an otherwise conventional vehicle, (such as an automobile or aircraft) moving in a normal manner in a natural environment (such as an outdoor test track). The invention incorporates in addition to the mobile vehicle, computer-based image generation devices, and position, velocity, acceleration, measurement instruments to enable the simulated visual hazard images, including operator perception of and response to those hazard images. Making the actual moving vehicle part of the simulated hazard encounter means the vestibular (motion) cues and visual cues of the natural environment are very realistic, while only the computer-generated hazard images imposed on the natural environment view are virtual.

U.S. Pat. No. 4,121,356 (Oct. 24, 1978) An installation for affording a motor vehicle driver practice to improve his reactions and behavior in an emergency situation. A shaft with a movably disposed symbol-bearing member therein is arranged in a test-roadway. Operating devices are provided for moving the symbol-bearing member partway out of the shaft and for completely returning the symbol-bearing member to within the shaft. An electric signal is produced by a device disposed in front of the shaft to control the operating devices when a motor vehicle approaches the shaft. The symbol-bearing member is suddenly caused to move out of the shaft when a motor vehicle approaches the shaft and returned before the vehicle reaches the symbol-bearing member.

### BRIEF SUMMARY OF THE INVENTION

The “Real Diving” driver education system combines specifically prepared surfaces of an outdoor driving training course extending a length of approximately 600 feet and computer-generated, “augmented reality” images. This system requires that the actual vehicle owned by the trainee or used in his/her employment be driven in the training scenarios. Several training devices integral to the prepared area send signals to a portable display, thereby presenting a variety of augmented driving environments to the driver. The trainee (driver, student) will drive his/her vehicle through various stages and simulations, thus exposing him/her to challenging driving situations. At least one hazardous condition simulation will be available per each drive through the training area. Failing to perform proper maneuvers will result in losing control over the vehicle and probable spins or slide-out. Applying adequate steering, braking, and/or acceleration corrections will result in successful execution of each scenario.

The disclosed system will provide a safe learning environment for drivers to learn and practice safe driving techniques. Another advantage is that the disclosed system will teach student drivers/trainees the extreme importance to stay focused on their driving environment. Any distractions, such as munching on food, conversation with passengers, cell phone operation, etc. will decrease the available time a driver has to react to hazards. The system will help trainees avoid accidents in critical situations and hazardous road conditions.

### BRIEF DESCRIPTION OF THE VIEWS OF THE DRAWINGS

FIG. 1 illustrates the physical layout of the Reality Driving Education System, showing the various sectors and components of the training area.

FIG. 2 illustrates the combination of real images and augmented reality images that may be presented to a driver/trainee during his/her driving session.

FIG. 3 depicts the orientation of the head mounted device that may be worn by a driver/trainee while occupying the driver's seat of the training vehicle.

FIG. 4 is a chart showing (a) the interconnected relationships between the visualization of images projected to the driver, (b) the source of vehicle performance information, and (c) the sensors and training devices located in the training area.

FIG. 5 is a flow chart depicting the sequence of events a driver/trainee undergoes while maneuvering the vehicle through the active training zone from start to finish.

FIG. 6 illustrates the layout of the water jets sector, comprising strategically-arranged water supply lines, quick acting solenoid valves and water nozzles, or jets.

FIG. 7 depicts the magnification of the inset portion of the water jets sector shown in FIG. 6.

FIG. 8 shows a vehicle passing abeam a sequenced eruption of water from adjacent water nozzles (jets), forming a water curtain.

FIG. 9 depicts a vehicle passing abeam a sequenced eruption of a water curtain and approaching a second water curtain which simulates an impending obstacle.

FIG. 10 illustrates the sequential movement of a vehicle which has failed to negotiate a head-on simulated obstacle, the obstacle having been enhanced in coordination with the eruption of a water curtain.

FIG. 11 illustrates the sequential movement of a vehicle successfully maneuvering to avoid a head-on collision with a water curtain-enhanced simulated obstacle.

### DETAILED DESCRIPTION OF THE INVENTIVE CONCEPT

The objects, features, and advantages of the concept presented in this application are more readily understood when referring to the accompanying drawings. The drawings, totaling eleven figures, show the basic components of the system and the methods of use. In the several figures, like reference numbers are used in each figure to correspond to the same component as may be depicted in other figures.

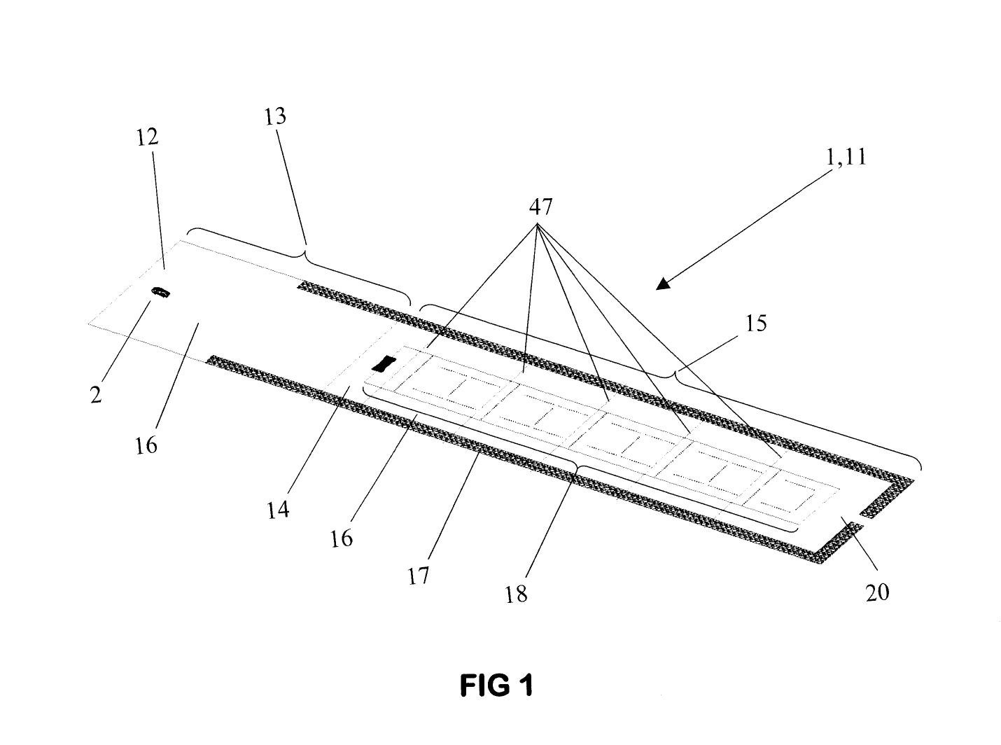

The discussion of the present inventive concept will be initiated with FIG. 1, which illustrates the general physical layout of the Reality Driving Education System (RDES) 1 and the training area 11. In the preferred embodiment, the RDES 1 is installed outdoors on relatively level ground. Other embodiments of RDES 1 may be installed on areas of sloping terrain to simulate uphill/downhill driving conditions.

The preferred embodiment of RDES 1 comprises dimensions of approximately six-hundred (600.0) feet in length and eighty (80.0) feet wide. Smaller, temporary embodiments of RDES 1 may be installed in a relatively short time (24 to 48 hours) on existing parking lots or other hard-surfaced areas commonly driven on by the public. An acceleration zone 13 comprises about one-third of the RDES length and an “active” training zone 15 occupies the remaining two-thirds of the training area 11. A vehicle 2 is depicted at the vehicle starting position 12 in preparation for a driving session through the training area 11. A RDES 1 course operator 31 coordinates and manages all field devices contained in the active training zone 15 and helps the driver 3 prepare for and understand the types of driver training scenarios to be executed.

The active training zone 15 comprises several low friction sectors 18 each of which is characterized by augmented reality image 33 and simulated hazards. A commercially available smooth-surfaced composite layer or other material may be used in the low friction sectors 18 of the active training zone 15. Also installed is an extensive water jets sector 22 comprising strategically-arranged, quick acting solenoid vales 43 and water supply lines 41, 42. The low-friction sectors 18 and the water jets sector 22 are surrounded by a standard friction control zone 16. The friction control zone 16 allows a driver to stop safely or regain control over the vehicle 2 should any of the low friction sectors 18 cause sliding or spinout of the vehicle 2.

Again referring to FIG. 1, to provide ultimate safety, the friction control zone 16 is surrounded with a “safety” zone 17 which may be composed of deep gravel (or similar materials used on professional automotive race tracks) to stop a vehicle 2 safely in the event the driver 3 is unable to gain control of the vehicle 2 in the control zone 16. After the driver 2 exits the end 20 of the low friction training sectors 18, he/she may return to the starting position 12 in order to repeat the same exercise or practice another sequence of training.

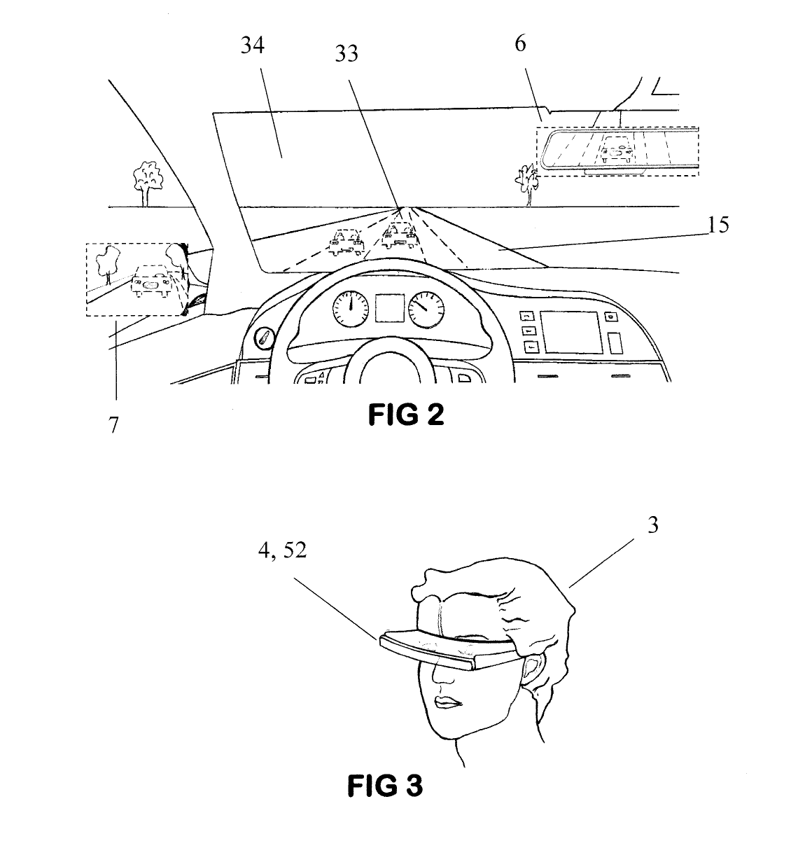

FIG. 2 illustrates the combination of real images and simulated images 33 that may be presented to a driver 3 during his/her driving session. In the cabin of the vehicle 2, simulated images 33 will be presented to the driver 3 by means of the surface of the lens of a Head-Mounted Device (HMD) 4 worn by the driver 3. Simulated versions of the rear view mirror 6 and side view mirror 7 are programmed to appear on the lens surface, along with appropriate augmented reality images 33 corresponding to the training exercise being performed by the driver 3. Simulated versions of the vehicle's 2 mirrors 6, 7 will be visible to the driver 3 on the top-center, left lower one-third, and right lower one-third lens surfaces of the HMD 4, but may not precisely overlay the actual surfaces of the mirrors 6, 7 on the vehicle 2.

Further, the windshield 34 of the vehicle 2 may receive projections of computer-generated augmented reality images 33. However, the vast majority of the windshield 34 surface allows the driver 3 unobstructed vision of real objects in the training area 11, particularly the outer edges of the active training zone 15 (as is shown in FIG. 2).

FIG. 3 depicts the orientation of the head-mounted device (HMD) 4 that may be worn by a driver/trainee 3 while occupying the driver's seat of the training vehicle 2. Some embodiments of the HMD 4 may utilize a gyro/head tracker 52 for more accurate renderings and placements of the augmented reality images 33. All HMD 4 units used in RDES 1 are commercially available devices and will, correspondingly, have differing technical preciseness. Examples of this field of technology include Microsoft® Holo-lens and similar products. Such devices are used to transform the RDES 1 training environment and the simulated driving conditions with the use of augmented reality techniques.

To perform the selected exercises, the driver 3 will use his/her own car and will be equipped with an audio-visual system 55 controlled by a portable computer, which computer functions as the RDES 1 control unit 107. The audio experience will be achieved with either headphones (headphones could be integrated into the HMD) or through the vehicle 2 audio system and its speakers connected to the portable computer. With this combination of inputs the driver 3 will see and hear the actual environment and additional simulated virtual hazardous or and/or distracting objects 33.

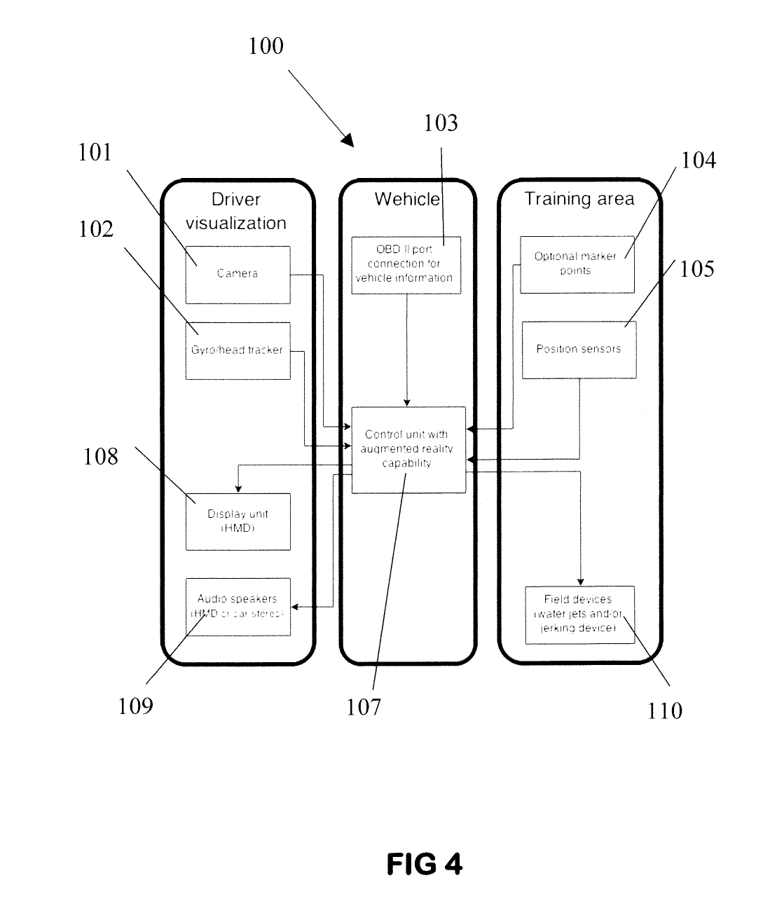

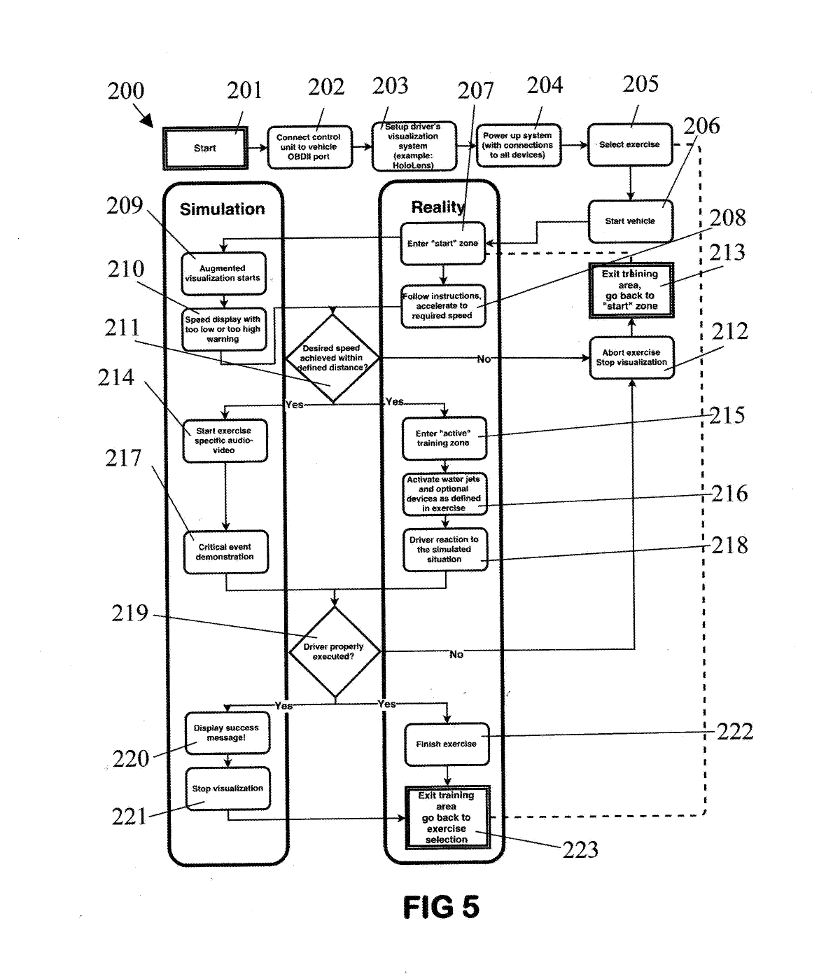

FIG. 4 sets forth the interconnected relationships between the generation of simulated images 33 projected to the driver 3, the source of vehicle 2 performance information, and a summary of the sensors and nature of the training devices located in the training area. A micro camera 101 which is located in the training vehicle 2, proximate the driver 3 captures images and sends those images to a control unit 107 having software capable of generating augmented reality images. A gyro-head tracker 52, 102 may be used to monitor the movements and orientation of the driver's 3 head and also send this information to the control unit 107.

The RDES 1 system is designed to use wireless technology or dedicated communications networks between the training area 11, field devices and sensors, and among the camera 101, control unit 107, HMD 4 and other components of the system. The training area 11 may be equipped with a plurality of marker points 104 which are specific visual indicators at various points along the active training zone 15 for the benefit of the driver 3. Also included are location sensors 104 and position markers 105 which continuously signal the vehicle 2 position to the control unit 107.

Upon receiving inputs from the above-described components, the control unit 107 then generates augmented reality images 33 to the driver display unit 108, 52 (refer to FIG. 3 and FIG. 4) and audio signals to the vehicle audio system 109 (or headphones worn by the driver). The control unit 107 additionally sends appropriately timed signals to the field devices installed in the active training zone 15, which may include water solenoid valves, a front or rear) axle yanking device 36, and other real or simulated hazards 33.

FIG. 5 presents a flow chart 200 showing the sequence of events a driver 3 or trainee undergoes while maneuvering the vehicle through the active training zone 15. The training sequence is initiated at a start sequence 201 convenient for the driver 3 and a course operator 31 At this point, the RDES 1 control unit 107 is connected to the On-Board Diagnostics (OBD) 53 port of the vehicle 2. In the next sequence 203, RDES 1 course operator 31 sets in the driver's 3 visualization system which, in the preferred embodiment, will be a head-mounted display (HMD) 4, or other electronic device capable of being used as a visual display of computer-generated graphics.

The course operator 31 helps the driver/trainee 3 with the operation of the HMD 4, vehicle 2 OBD 53 plug-in, control unit 107 placement and setup, and helps to select a desired training exercise. The foregoing matters are all accomplished before the driver 3 entering training area 11. Once the RDES 1 system is deemed to be fully functional by the course operator 31 and driver 3 indicates he/she is ready (exercise selected, audio/video tested) then the driver 3 drives the vehicle to the vehicle starting position 12. Communications is then established 204 to all vehicle 2 training equipment and the field devices located in the active training zone 15. The training exercise has previously been agreed upon and selected. Once in position, the lens or screen of the HMD 4 will receive projections of instructions which will guide the driver 3. For example “steer straight ahead,” “speed up to xx mph,” are typical messages/instructions to be transmitted to the driver/trainee 3.

The driver 3, having entered the vehicle 2 places his/her head-mounted display 4 in a comfortable position, allowing freedom movement of the eyes for scanning the lens and/or screen of the HMD 4. The engine is started 206. In the next sequence 207 the driver 3 maneuvers his/her vehicle to the starting position 12. Following the instructions 208 displayed on the HMD 4, the driver 3 accelerates the vehicle 2, in the acceleration zone 13, to the speed required by the selected training exercise. While the driver 3 is achieving desired speed for the exercise, the control unit 107 activates and starts augmented reality generators which are synchronized with vehicle 2 position and speed in the active training zone 15. A digital interface to the vehicle's 2 systems, particularly the OBD II 53, can be used to increase the accuracy of the overlay of the virtual simulation. Immediately following vehicle speed stabilization in the acceleration zone 13, the driver 3 crosses the entry zone 14 into the active training zone 15. There is no further action required by the course operator 31 at this point. The RDES 1, since it has been pre-programmed, automatically activates the augmented visualization imaging 209 appropriate to the exercise. The vehicle's 2 location and speed will trigger augmented reality “components” for display to the driver 3.

If the vehicle 2 speed is improper for the training exercise, (the control unit 107 will determine if the vehicle 2 has reached the desired speed 211 within the acceleration zone 13), the control unit 107 will abort the exercise and will message the driver 3 through an on-screen HMD 4 message to abort the exercise 212, and the augmented visualizations 33 will also be terminated. The vehicle's 2 speed indication is part of the visualization displayed on the HMD 4 and the driver 3 will be warned for too high or too low a speed (or for being off-course). If no correction is made within the available time and space allowed for the training, the exercise will automatically be aborted. No action from the course operator 31 will be required. The driver 3 must then exit the active training area 15 and drive the vehicle 2 back to the starting position 12, 213.

Again referring to FIG. 5, if the vehicle 2 speed attained in the acceleration zone 13 is proper for the training exercise, the control unit 107 will begin an exercise-specific video 214. Position sensors 105 inside the active training zone 15 will continuously relay the position of the vehicle 2 to the control unit 107 which then synchronizes the generation of augmented reality images 33 and the audio presentations to the driver's 3 HMD 4.

At approximately the same time 215, the driver 3 will pass the entry zone 14 and the vehicle enters the active training area 15. Based on the on the program selected, the control unit 107 activates at least one of the field devices designated for the specific training exercise 216 to be performed by the driver 3. A hazardous or critical situation is presented 217 to the driver, essentially by means of the augmented reality images 33 instantly displayed, by means of the driver's 3 HMD 4, or in the rear view mirror 6, and in the side mirror(s) 7. The mirrors 6, 7, will continuously form realistic rear view visualizations of the actual and simulated images presented to the driver 3. However the images may not precisely overlay the actual mirrors surface of the vehicle 2. The driver 3 is forced to immediately react to the presented danger through the augmented reality images 33, as his/her instincts demand 218.

Viewing FIG. 5, a determination is made as to whether the driver 3 properly executed an acceptable maneuver to avoid the hazardous or critical situation 219. If the active training zone 15 position sensors 105, vehicle speed, and other automatic inputs indicate that the driver 3 failed to maintain proper control of the vehicle 2 during the hazardous or critical situation, the exercise is automatically aborted 212. However, if there are indications that the driver 3 properly executed an avoidance maneuver with the vehicle 2, then a “successful” message is displayed 220. The generation of augmented reality images is terminated 221, and the exercise is completed 222. The driver 3 then exits the active training zone 15 and the course operator 31 gives new directions to the driver 3 for the performance of the next training maneuver 223, if any.

To add to the feeling of realism during driver training, “water curtains” 46, 46(a), 46(b) are vertically emitted by in-ground water nozzles (or jets) 44, which are controlled by quick-acting solenoid valves 43. The generation of these water curtains 46, 46(a), 46(b) gives a sensation of the vehicle 2 colliding with an actual object when the driver 3 mis-navigates one of the exercises designed for the active training zone 15. The water curtains 46, 46(a), 46(b) are generated by the activation of quick-acting solenoid valves 43 and water jets 44 strategically arrayed in a water jets sector 22 of the active training zone 15. By use of the term “strategically”, the function of the design and array of the solenoid valves 43 and water jets 44 is understood to be arranged such as to form simulated obstacles (water curtains) generally parallel to, or perpendicular to, the course of the vehicle 2 when the driver 3 transitions through the active training zone 15.

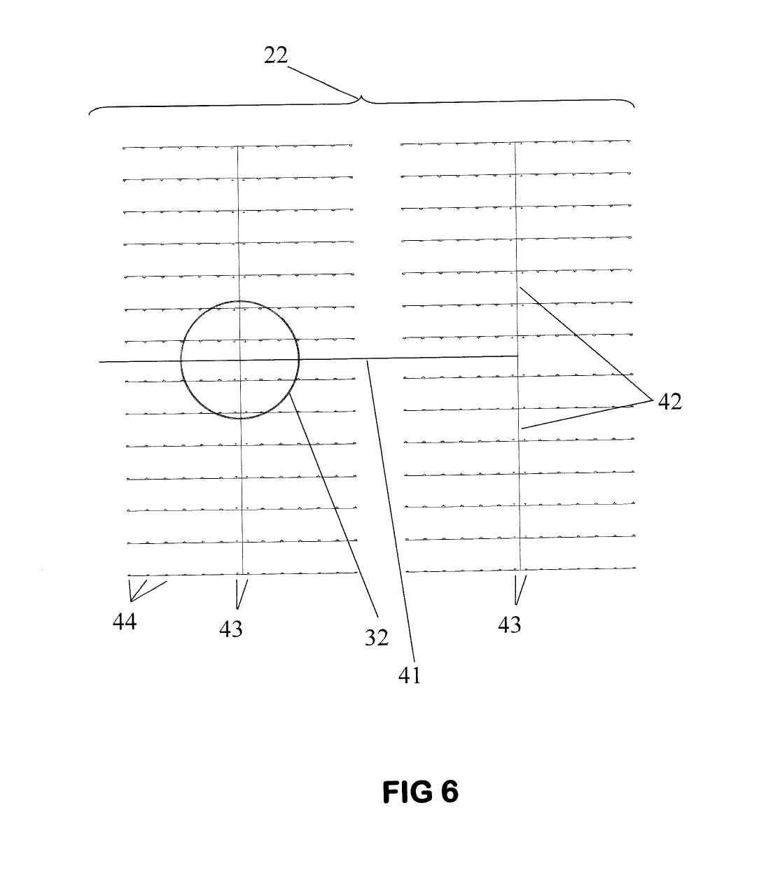

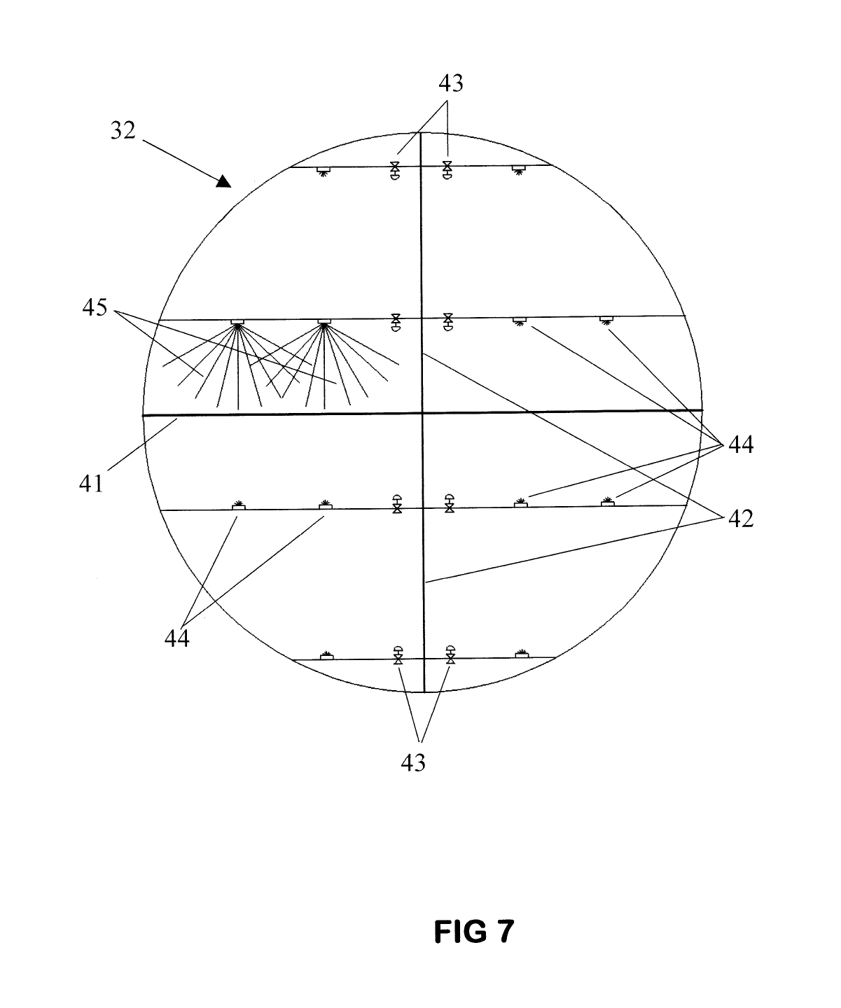

FIG. 6 presents a portion of the water jets sector 22, further showing a main water supply line 41, secondary water lines 42, solenoid valves 43, and water jets or nozzles) 44. In FIG. 7 there is displayed a magnification of the inset 32 portion shown in FIG. 6, showing in greater detail the main water supply line 41, secondary water lines 42, solenoid valves 43, and water jets 44. Also shown in FIG. 7, for illustrative purposes only, are two illustrations of vertically ejected water streams 45 emitted from two of the water jets 44.

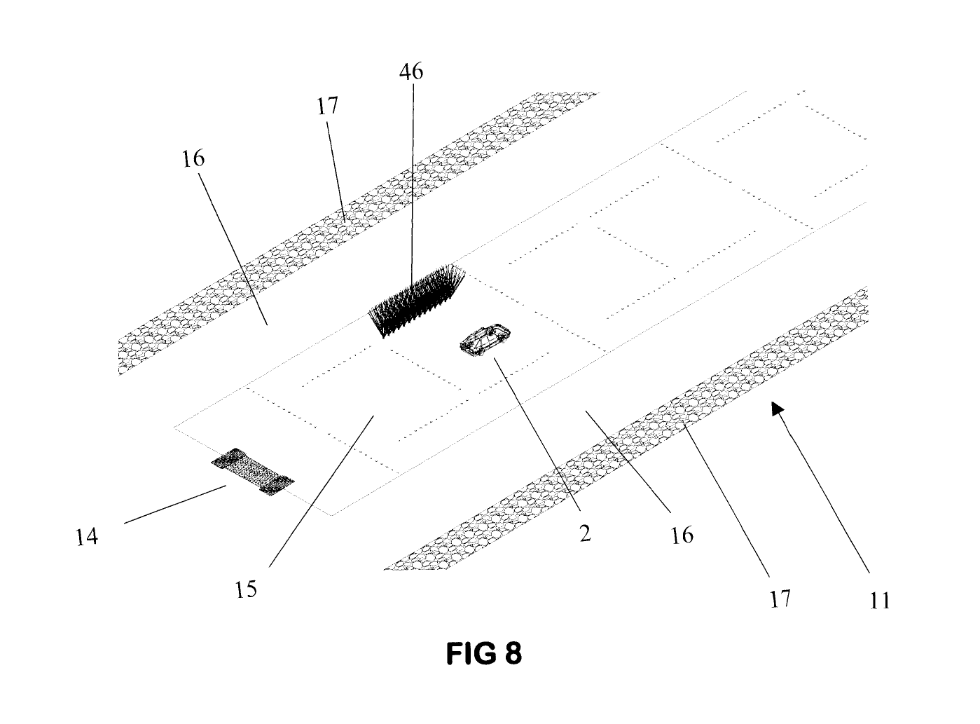

Reviewing additional details of the RDES 1, FIG. 8 displays a vehicle 2 shortly after passing the entry zone 14 of the active training zone 15 and entering the water jets sector 22. In accordance with the training exercise to be undergone by the vehicle 2 shown, a water curtain 46 has been activated to the left of the vehicle. The water curtain 46 could represent a nearby moving vehicle, a fixed obstacle, a hazardous road condition, or other critical matter that the driver 3 is made aware of.

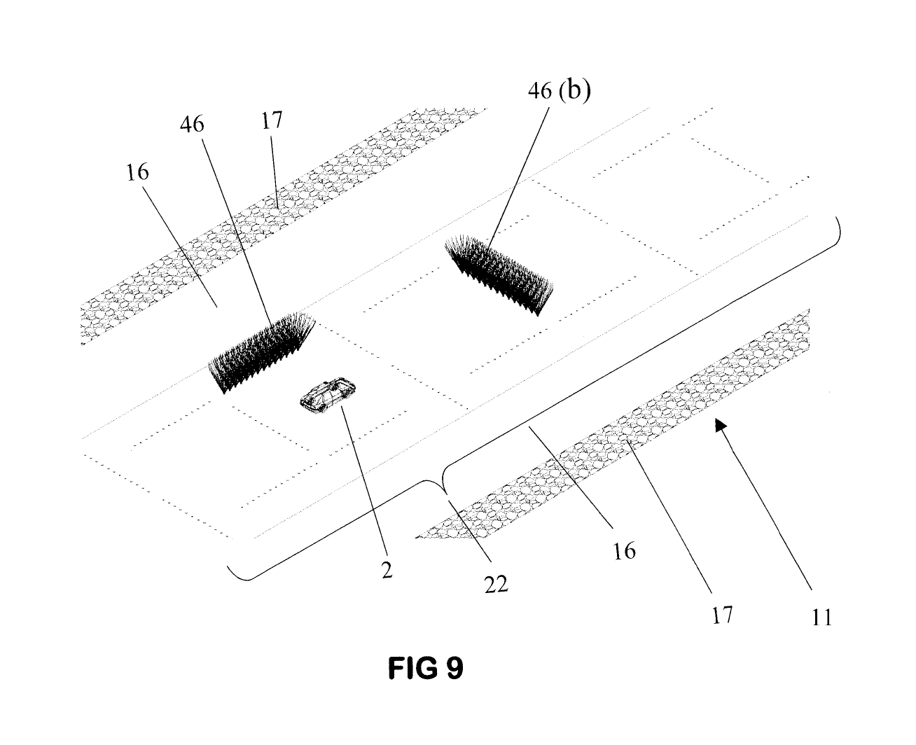

Continuing in this scenario, FIG. 9 displays a situation in which the driver 3 of the vehicle 2 is suddenly confronted with a water curtain 46(b) simulating a hazardous road condition or obstacle directly in the projected path of the vehicle 2. In all likelihood, the water curtain 46(b) has been activated in conjunction with the simultaneous generation of augmented reality images 33, which images reinforce the visual sensation of the actual existence of the hazard in the exact position of the water curtain 46(b).

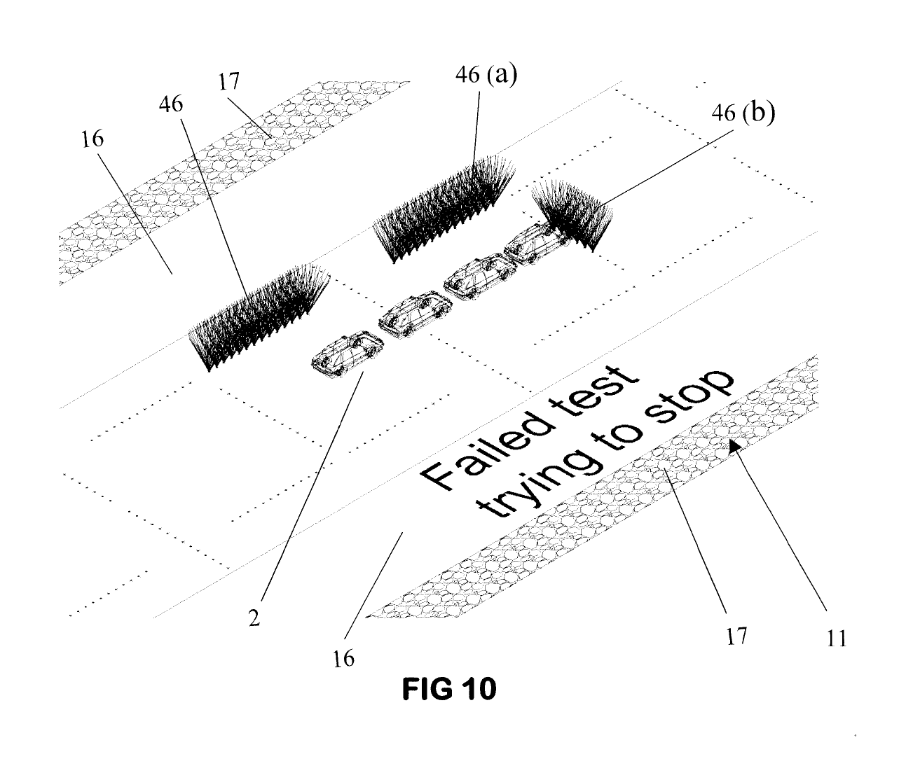

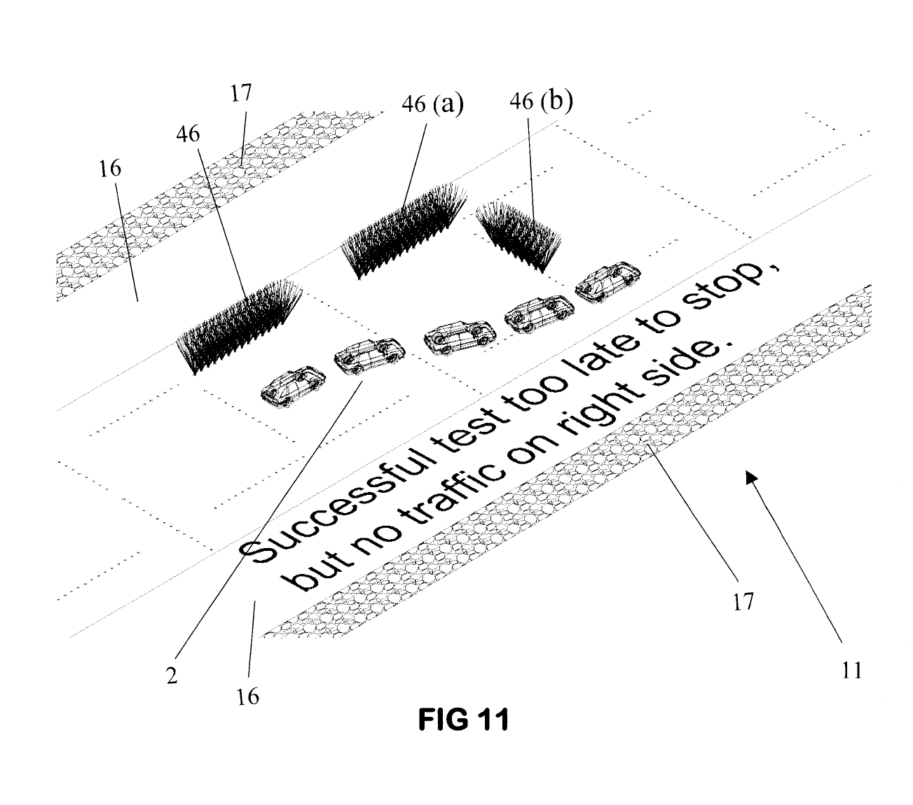

Continuing further into the developing details of the above-described driving scenario, FIG. 10 illustrates the efforts of the driver 3 in applying the brakes of the vehicle 2 and attempting to stop prior to colliding with the hazard represented by the water curtain 46(b). The driver 3 had no safe option to steer to the left around the water curtain/hazard 46(b), as a second water curtain 46(a) representing a continuation of the hazard to the left of the vehicle 2, is synchronized to be apparent to the left of the vehicle 2. The second curtain 46(a) could easily be enhanced in the HMD 4 (by augmented reality images 33) as an oncoming vehicle in the adjacent lane or continuous opposite-direction traffic. As a result of the driver's 3 simulated collision with the obstacle represented by the water curtain 46(b), the driver 3 must exit the active training zone 15 and return to the vehicle starting position 12 for another training session.

FIG. 11 presents a situation where the driver 3 of the vehicle 2 has successfully executed a maneuver, probably a combination of braking and steering to the right, (as there is no simulated danger on the right side of the course), in order to avoid colliding with the obstacle represented by water curtain 46(b). The training scenarios illustrated by FIGS. 9, 10, and 11 may be made more difficult in other sectors of the active training zone 15 where the surface of the sector may be that of an industrial-type low friction material simulating an icy road.

Other embodiments of the RDES 1 may include installation of a front (or rear) axle-yanking device within the active training zone 15. The axle-yanking field device serves to force vehicle 2 of balance and make it enter into a slide. The axle-yanking device forces drivers to experience the sensation of loss-of-control and sidewise G forces. This training exercise would enable a driver 3 to learn how to gain back vehicle 2 control without crashing the vehicle. The axle-yanking device typically′ will comprise an approximately 6.0 foot×12.0 foot sliding metal plate installed flush with the surface of the training course. The ax device being, powered by hydraulic, pneumatic, or electric servo drives, may move left or right upon receipt of an instantaneous signaling of the position of the axle of the vehicle 2 from the RDES 1 control unit 107.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

What is claimed is:

1. An automotive driver training and education system comprising
a specifically-dimensioned, outdoor driving closed course comprising a length of level straightaway, said straightaway further comprising a starting point, a certain length of the surface of said straightaway being paved with a common, road-like friction material, an entry zone, an active training zone having a plurality of sectors, with at least two sectors consisting of low to-medium friction surfaces, a hard-surfaced high-friction boundary encompassing said active training zone, a safety zone bordering and abutting all outer edges of said hard surfaced high-friction boundary, said safety zone comprising a layer of gravel manifesting to a certain depth below the surface of said high-friction boundary;
a sector in said active training zone comprising a main water supply line, strategically-arrayed secondary water supply lines branching from said main water supply line and feeding a plurality of quick-acting solenoid valves, said solenoid valves further being routed to vertically-oriented water jets, said water jets having orifices capable of ejecting vertical water streams;
position sensors arranged at intervals along the length of said active training zone, said position sensors utilized to send electronic information of a test vehicle's position and speed to the control unit;
a head-mounted display having an internal screen or lens for the projection of electronic images onto said screen or lens, said head-mounted display for the wearing by the operator of a vehicle to be utilized in maneuvering within said active training zone;
a control unit comprising a portable computer having software programmable for the operation of said water jets in synchronization with the position of a vehicle transiting the course, and simultaneously, the corresponding rendering of specially-designed augmented images corresponding to the same position of the vehicle, said images projectable onto the interior lens or screen of said head-mounted display;
at least one micro-camera, either integrated into the HMD or affixed to the head-mounted display, or proximate the head of the operator of a vehicle, said vehicle to be driven within said active training zone; wherein
upon programming the control unit of said system for a specific training exercise, and an operator commencing driving a vehicle within said active training zone, said control unit thereupon projects certain electronic images onto the head-mourned display of the operator and further, initiates the synchronized ejection of vertical streams of water from said jets installed at locations corresponding to the simulated position of electronic augmented images appearing in the head-mounted device worn by said operator of the vehicle.

2. An automotive driver training and education system as in claim 1 wherein said straightaway comprises dimensions of approximately six hundred (600.0) feet in length and approximately eighty (80.0) feet in width; said head-mounted display further comprises an audio system and a gyrohead tracker; coded and/or specific visual marker points for indication to a vehicle driver specific areas and sectors of said active training zone; and installation of an axle-yanking device.

3. A method for instructing the driver of an automotive vehicle as in claim 4, wherein said outdoor closed driving closed course is constructed on hilly terrain with at least one incline and at least one course declination comprise said course.

4. A method for instructing the driver of an automotive vehicle in the safe and efficient maneuvering of the vehicle by means of combining the simulated encountering of hazardous driving conditions and real-time actual driving conditions, both conditions occurring on a prepared and specially surfaced outdoor driving course wherein the driver is required to operate his/her own privately-owned or business-use vehicle in a specific range of vehicular speeds while subjected to said simulated and actual driving conditions, the method comprising the steps of:
grading, paving, and preparing a specifically-dimensioned outdoor driving closed course comprising a length of straightaway, said straightaway further comprising a starting point, a certain length of the surface of said straightaway being paved with a common road-like friction material, an entry zone, an active training zone having a plurality of sectors, with at least two sectors consisting of low to-medium friction surfaces, a hard-surfaced high-friction boundary encompassing said active training zone a safety zone bordering and abutting all outer edges of said hard-surfaced high-friction boundary, said safety zone comprising a layer of gravel manifesting to a certain depth below the surface of said high-friction boundary;
installing a sector in said active training zone comprising a main water supply line, strategically-arrayed secondary water supply lines branching from said main water supply line and feeding a plurality of quick-acting solenoid valves, said solenoid valves further being routed to vertically-oriented water jets, said water jets having orifices capable of ejecting vertical water streams;
installing position sensors arranged at intervals along the length of said active training zone, said position sensors utilized to send information to the control unit;
providing a head-mounted display having an internal screen or lens for the projection of electronic images onto said screen or lens, said head-mounted display for the wearing by the operator of a vehicle to be utilized in maneuvering within said active training zone;
providing a control unit comprising a portable computer having software programmable for the operation of said water jets in synchronization with the position of a vehicle transiting the course, and simultaneously, the corresponding rendering of specially-designed augmented images corresponding to the same position of the vehicle, said images projectable onto the interior lens or screen of said head-mounted display;
providing at least one micro-camera affixed to the head-mounted display, or proximate the head of the operator of a vehicle, said vehicle to be driven within said active training zone;
providing a course operator for initial programming of the control unit of said system for a specific training exercise; and
directing a driver to commence operation of a vehicle through said course while adhering to functional instructions transmitted to the head-mounted device, and further, maneuvering said vehicle so as to avoid the real and simulated hazards generated by images received in the head-mounted device.

5. A method for instructing the driver of an automotive vehicle as in claim 4, wherein said straightaway comprises dimensions of approximately six hundred (600.0) feet in length and approximately eighty (80.0) feet in width; said head-mounted display further comprises an audio system and a gyrohead tracker; coded and/or specific visual marker points for indication to a vehicle driver specific areas and sectors of said active training zone; and installation of an axle-yanking device.

6. A method for instructing the driver of an automotive vehicle as in claim 4, wherein said outdoor closed driving closed course is constructed on hilly terrain with at least one incline and at least one course declination comprise said course.
